(19) United States
(12) Patent Application Publication
(10) Pub. No.: US 2006/0268055 A1
(43) Pub. Date: Nov. 30, 2006

(54) METHOD OF COMPENSATING FOR AN INK DROP OFFSET ON PRINT MEDIA

(76) Inventors: Dao-Yueh Wu, Taipei Hsien (TW); Chien-Hsien Ho, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/420,227

(22) Filed: May 25, 2006

(30) Foreign Application Priority Data
May 26, 2005 (TW) 094117235

(51) Int. Cl. B41J 23/00

(52) U.S. Cl. 347/37; 347/19

(57) ABSTRACT

An ink-jetting time is set according to a moving speed of a print head while the print head operates. The ink-jetting time has a short delay when the moving speed is a little lower than a maximum moving speed, and has a longer delay when the moving speed is much lower than the maximum moving speed. The ink-jetting time is not delayed when the print head moves at the maximum moving speed.

### BACKGROUND OF THE INVENTION

1. Field of the Invention

The present invention relates to a method of compensating for an ink drop offset on print media, and more particularly, to a method of compensating for an ink drop offset by delaying a print head jetting ink.

2. Description of the Prior Art

Ink jet printers provide good printing quality at a fair price and as a result, have become one of the most popular types of printing equipment. With the quick advancement in technology, better printing quality has become a target that the information industry works to achieve.

Generally, a print head moves in the horizontal direction back and forth. While the print head enters a printing region, the print head starts to jet ink onto a print medium. An ink drop jetted from a nozzle of the print head has a horizontal speed the same as that of the print head. Since the ink drop has such a horizontal speed, the position of the ink drop on the print media has an offset.

In order to control ink drop offset on print media, most ink jet printers control the print head to move at a stable speed within the printing region for high printing quality, so that the horizontal speed of the print head has little influence on the ink drop offset. Additionally, there should be a space at each side of the printing region for acceleration and deceleration of the print head. These two spaces not only increase printing time, but also increase the physical size of the printer, which wastes space and material.

Some ink jet printers provide different printing speeds or different printing resolutions to the user, neglecting the horizontal precision of printing. While the print head enters the printing region, the print head is still accelerated so as to decrease printing time, leading to image distortion.

Please refer to FIG. 1, which is a diagram of moving speed of the print head. As mentioned above, the print head must be accelerated to a maximum speed Sₘₐₓ. However, in order to decrease printing time, the print head starts to jet ink when the moving speed is increased to Sₐ (at time point t1). When the print head enters the deceleration region, the print head stops jetting ink while the moving speed is lower than Sₐ (after time point t4). From FIG. 1, the printing region is the range between time points t1 and t4. However, the print head only moves at speed Sₘₐₓ stably in the range between time points t2 and t3. The acceleration and deceleration of the print head are in the range between time points t1 and t2, and the range between time points t3 and t4, respectively. Hence, ink drops jetted between time points t2 and t3 have the same offset on the print media. Ink drops jetted between time points t1 and t2 and between time points t3 and t4 have different offsets, and as a result, the printed image is distorted.

Please refer to FIG. 2 and FIG. 3, which are diagrams of the print head 10 moving at different speeds. As shown in FIG. 2, suppose that a travel time of the ink drop jetted from the print head 10 to the print medium 12 is T_{drop}, and the horizonta1 moving speed of the print head 10 is Sₐ. Due to the moving speed Sₐ in the horizonta1 direction, the ink drop jetted at the point a1 by the print head 10 falls on a point a2 of the print medium 12. The distance between a1 and a2 is the ink drop offset Xₐ. In FIG. 3, the horizonta1 moving speed of the print head 10 is Sₘₐₓ. The ink drop jetted at the point m1 falls on the point m2 of the print medium 12, resulting in the ink drop offset Xₘₐₓ. From the examples of FIG. 2 and FIG. 3, the ink drop offset at the moving speed Sₐ is different from the ink drop offset at moving speed Sₘₐₓ, and thereby leads to image distortion.

### SUMMARY OF THE INVENTION

It is therefore a primary objective of the claimed invention to provide a method of compensating for an ink drop offset on print media to solve the above-mentioned problem.

The claimed invention provides a method of compensating for an ink drop offset on print media. The method comprises delaying a print head of an inkjet printerjetting ink while a moving speed of the print head is smaller than a reference speed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of moving speed of a print head according to the prior art.

FIG. 2 and FIG. 3 are diagrams of a print head moving at different speeds.

FIG. 4 is an illustration of ink drop alignment according to the present invention.

### DETAILED DESCRIPTION

In order to solve the problem of ink drop offsets on print media when a print head moves at different speeds, the present invention takes a reference offset at a reference speed as standard to calculate delay times for different moving speeds. According to the delay time, the present invention delays the print head jetting ink at the corresponding moving speed so as to make each ink drop offset on a print medium the same. Thus, the prior art problem of image distortion resulting from different ink drop offsets can be solved.

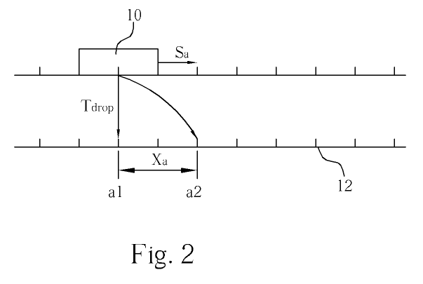

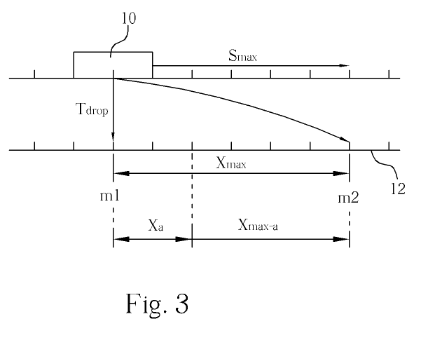

Please refer to FIG. 2 and FIG. 3 again to shed light on how to delay the print head 10 jetting ink to compensate for ink drop offsets. The present invention takes the maximum moving speed Sₘₐₓ of the print head 10 as standard. While the print head 10 prints at the maximum moving speed Sₘₐₓ, the ink drop offset Xₘₐₓ is regarded as a reference offset. The present invention makes each ink drop offset on the print medium 12 the same as the reference offset Xₘₐₓ, wherein Xₘₐₓ is approximately derived from Sₘₐₓ multiplied by T_{drop}. Therefore, when the moving speed of the print head 10 is smaller than Sₘₐₓ, the present invention delays the print head 10 jetting ink so as to compensate for the ink drop offset. For example, if the moving speed of the print head 10 is Sₐ resulting in an ink drop offset Xₐ approximately derived from Sₐ multiplied by T_{drop} as shown in FIG. 2, the difference of Xₐ and Xₘₐₓ, Xₘₐₓ−Xₐ or Xₘₐₓ₋ₐ, must be compensated. According to Xₘₐₓ₋ₐ and Sₐ, a delayed time T_{delay} while the print head 10 moves at the speed Sₐ can be calculated by the following equations:
T_{delay}=Xₘₐₓ₋ₐ/Sₐ equation (1a)
T_{delay}=(Xₘₐₓ−Xₐ)/Sₐ equation (1b).

Equations (1a) and (1b) can be combined to form the following equation:
T_{delay}=T_{drop}×(Sₘₐₓ−Sₐ)/Sₐ equation (2),

wherein T_{drop} is a travel time of the ink drop jetted from the print head 10 to the print medium 12, and is derived from the following equation.
T_{drop}=L_{drop}/S_{drop} equation (3),

wherein L_{drop} is a distance between the print head 10 and the print medium 12, and S_{drop} is an average speed of ink drops jetted from the print head 10 to the print medium 12 while the print head 10 does not move.

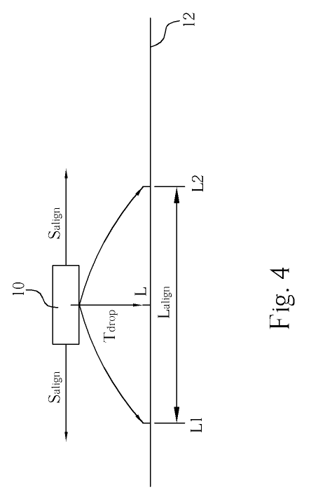

Additionally, T_{drop} can be derived from an alignment shown in FIG. 4, which is an illustration of ink drop alignment. In FIG. 4, the print head 10 moves at an alignment speed S_{align} back and forth, and jets an ink drop when the print head 10 is at a predetermined point L. Therefore, two ink drops fall on points L1 and L2 of the print medium 12. L_{align} is the distance between points L1 and L2. T_{drop} is approximately derived from the following equation:
T_{drop}=1/2×L_{align}/S_{align} equation (4)

As know in the art, it is not easy to measure moving speed directly, which requires a speed meter and increases the cost and the physical size of machine. Thus, the present invention replaces a speed meter with a control chip for time measurements, and with a position encoder for reporting distance differences. As a result, T_{delay} of equation (2) can be converted as such:
T_{delay}=(Sₘₐₓ−Sₐ)/Sₐ×T_{drop}
T_{delay}=(Lₚᵣₑ/T_{Smax}−Lₚᵣₑ/T_{Sa})/(Lₚᵣₑ/T_{Sa})×T_{drop}
T_{delay}=(T_{Sa}−T_{Smax})/T_{Smax}×T_{drop} equation (5),

wherein Lₚᵣₑ is a predetermined distance, T_{Smax} is a time required to move at the speed Sₘₐₓ the predetermined distance Lₚᵣₑ, and T_{Sa} is a time required to move at the speed Sₐ the predetermined distance Lₚᵣₑ.

Therefore, without a speed meter, the present invention can still calculate T_{delay} to delay the print head 10 jetting ink.

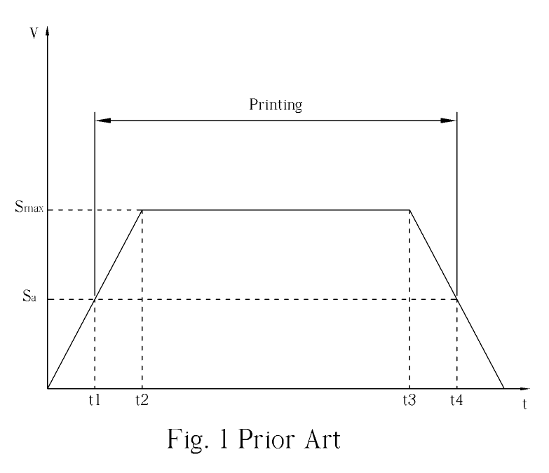

With the method of the present invention, no matter what the moving speed of the print head 10 is, each ink drop offset on the print medium 12 is approximately the same. Between time points t1 and t2 and between time points t3 and t4 in FIG. 1, the print head 10 is delayed in jetting ink according to the moving speed. That is, an ink-jetting time has a short delay when the moving speed is a little lower than the maximum moving speed Sₘₐₓ, and the ink-jetting time has a longer delay when the moving speed is much lower than the maximum moving speed Sₘₐₓ. The ink-jetting time is not delayed when the print head 10 moves at the maximum moving speed Sₘₐₓ during the range of time points t2 and t3. Therefore, the present invention can print images more precisely than the prior art, and thereby reduce image distortion. Additionally, the present invention can obtain the delay time T_{delay} without requiring a speed meter, and thus, does not increase the physical size of the printer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of compensating for an ink drop offset on a print medium, the method comprising:
delaying a print head of an ink jet printer jetting ink while a moving speed of the print head is smaller than a reference speed.

2. The method of claim 1 further comprising:
generating a reference offset according to the reference speed and a travel time of an ink drop jetted from the print head to the print medium;
generating a predetermined offset according to the moving speed of the print head and the travel time of the ink drop; and
generating a delay time according to the reference offset, the predetermined offset, and the moving speed of the print head;
wherein delaying the print head of the ink jet printer jetting ink comprises delaying the print head jetting ink at the moving speed according to the delay time.

3. The method of claim 2 further comprising generating the travel time according to a distance from the print head to the print medium and an average speed of an ink drop jetted from the print head to the print medium while the print head does not move.

4. The method of claim 2 further comprising generating the travel time according to the moving speed of the print head and a distance between an ink drop jetted at a predetermined point while the print head moves at the moving speed in a first direction and an ink drop jetted at the predetermined point while the print head moves at the moving speed in a direction opposite the first direction.

5. The method of claim 1 further comprising:
generating a delay time according to the reference speed, the moving speed of the print head, and a travel time of an ink drop jetted from the print head to the print medium;
wherein delaying the print head of the ink jet printer jetting ink comprises delaying the print head jetting ink at the moving speed according to the delay time.

6. The method of claim 5 further comprising generating the travel time according to a distance from the print head to the print medium and an average speed of an ink drop jetted from the print head to the print medium while the print head does not move.

7. The method of claim 5 further comprising generating the travel time according to the moving speed of the print head and a distance between an ink drop jetted at a predetermined point while the print head moves at the moving speed in a first direction and an ink drop jetted at the predetermined point while the print head moves at the moving speed in a direction opposite the first direction.

8. The method of claim 1 further comprising:
generating a delay time according to a time required to move at the reference speed a predetermined distance, a time taken by the print head to move at the moving speed the predetermined distance, and a travel time of an ink drop jetted from the print head to the print medium;
wherein delaying the print head of the ink jet printer jetting ink comprises delaying the print head jetting ink at the moving speed according to the delay time.

9. The method of claim 8 further comprising generating the travel time according to a distance from the print head to the print medium and an average speed of an ink drop jetted from the print head to the print medium while the print head does not move.

10. The method of claim 8 further comprising generating the travel time according to the moving speed of the print head and a distance between an ink drop jetted at a predetermined point while the print head moves at the moving speed in a first direction and an ink drop jetted at the predetermined point while the print head moves at the moving speed in a direction opposite the first direction.

11. The method of claim 1 wherein the reference speed is a maximum moving speed of the print head.
